(19) United States
(12) Patent Application Publication
(10) Pub. No.: US 2018/0040015 A1
(43) Pub. Date: Feb. 8, 2018

(54) SYSTEM FOR RESOURCE ALLOCATION AND CONSERVATION OF UNUSED PORTION

(71) Applicant: BANK OF AMERICA CORPORATION, Charlotte, NC (US)

(72) Inventors: Matthew Hsieh, Charlotte, NC (US); Caitlin Chrisman Bullock, Durham, NC (US)

(21) Appl. No.: 15/231,341

(22) Filed: Aug. 8, 2016

(51) Int. Cl. G06Q 30/02

(52) U.S. Cl. CPC G06Q 30/0233

(57) ABSTRACT

A resource allocation and conservation system comprises a network communication interface and a memory device storing a resource allocation and conservation application. A processing device is operatively coupled to the memory device, wherein the processing device is configured to execute computer-readable program code to: receive a user resource data based on a user resource activity from a third party system associated with one of a plurality of independent third parties; and update a user record in the memory device with a user resource based on the user resource data and allocate the resource. A resource means a user benefit developed as a result of a user transaction with a third party or developed as a result of the user's relationship with a financial institution. A user resource generating activity may be a transaction such as the purchase of services or goods, the use of a credit card or the like.

### BACKGROUND

Systems for providing a person with rewards for engaging in desired commercial transactions are known where a person may receive rewards such as loyalty points, cash-back, rebates, price discounts and the like for using an entities products or services. For example a retailer may provide price discounts when a loyalty card is presented at the time of purchase, an airline may offer redeemable points or miles when a flight is purchased, a credit card provider may offer a cash-back reward when the credit card is used. The person must track, account for and remember to use such rewards where the rewards originate from a wide variety of independent sources, provide different types of rewards on different terms and conditions and are redeemable under a wide variety of circumstances and time frames. As a result, even where such rewards are earned the rewards are often not allocated appropriately and unused rewards may be lost.

### BRIEF SUMMARY

In some embodiments a resource allocation and conservation system comprises a network communication interface and a memory device storing a resource allocation and conservation application. A processing device is operatively coupled to the memory device, wherein the processing device is configured to execute computer-readable program code to: receive a user resource data based on a user resource activity from a third party system associated with one of a plurality of independent third parties; and update a user record in the memory device with a user resource based on the user resource data and allocate the resource.

In one embodiment “resource” means a user benefit developed as a result of a user transaction with a third party or developed as a result of the user's relationship with a financial institution. Examples of a user benefit are discounts, cash back rewards, loyalty program points, price reductions or the like. A user resource generating activity may be a transaction such as the purchase of services or goods, the use of a credit card or the like. The user resource may be received at the time of the user resource activity. The user resource comprising a monetary payment may be swept into a user designated account. The user record may be accessible via a user device. The user record may track progress toward a predefined goal. The user resource may comprise points and the user record may comprise a tally of accumulated points and the processing device may receive an accounting of redeemed points from the third party system.

In some embodiments a method for allocating and conserving resources comprises: receiving user resource data based on a user resource activity from a third party system associated with one of a plurality of independent third parties; and updating a user record in the memory device with a user resource based on the user resource data and allocating the resource by tallying and or sweeping the user resource.

The user resource activity may comprise a financial transaction with the third party. The method may further comprise receiving the user resource at the time of the transaction. The user resource may comprise a user benefit including at least one of monetary payment, a rebate, a discount, a reward, and a point. The user resource may comprise a monetary payment and the method may further comprise including sweeping the monetary payment into a user designated account. The method may comprise further receiving a request for the user record from a user device. The user resource may be tracked for progress toward a predefined goal. The user resource may comprise a saved amount and the method may further comprise sweeping a monetary amount from a first user account into a second designated user account where the monetary amount is equal to the saved amount. The user resource may comprise points and the method may further comprise tallying accumulated points in the user record and receiving an accounting of redeemed points from the third party system.

In some embodiments a resource allocation and conservation system comprises a network communication interface and a memory device storing a resource allocation and conservation application. A processing device is operatively coupled to the memory device, wherein the processing device is configured to execute computer-readable program code to: receive user resource data in a secured message, the user resource data based on a user resource activity from a third party system associated with one of a plurality of independent third parties; and allocate a user resource based on the user resource data to tally and/or sweep the user benefit. The user resource activity may relate to a transaction with the third party where the transaction generates the user resource.

### BRIEF DESCRIPTION OF THE DRAWINGS

FIG. 1 is a block diagram illustrating the environment of a system for resource allocation and conservation, in accordance with embodiments of the invention.

FIG. 2 is a block diagram illustrating the mobile computing device of FIG. 1, in accordance with embodiments of the invention.

FIG. 3 is a block diagram illustrating the personal computing device of FIG. 1, in accordance with embodiments of the invention.

FIG. 4 is a block diagram illustrating the financial institution system of FIG. 1, in accordance with embodiments of the invention.

FIG. 5 is a block diagram illustrating the third party system of FIG. 1, in accordance with embodiments of the invention

FIG. 6 is a schematic diagram and flowchart illustrating the arrangement of a system and method for resource allocation and conservation, in accordance with embodiments of the invention.

FIGS. 7 and 8 show a flowchart useful for illustrating a method for resource allocation and conservation, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like.

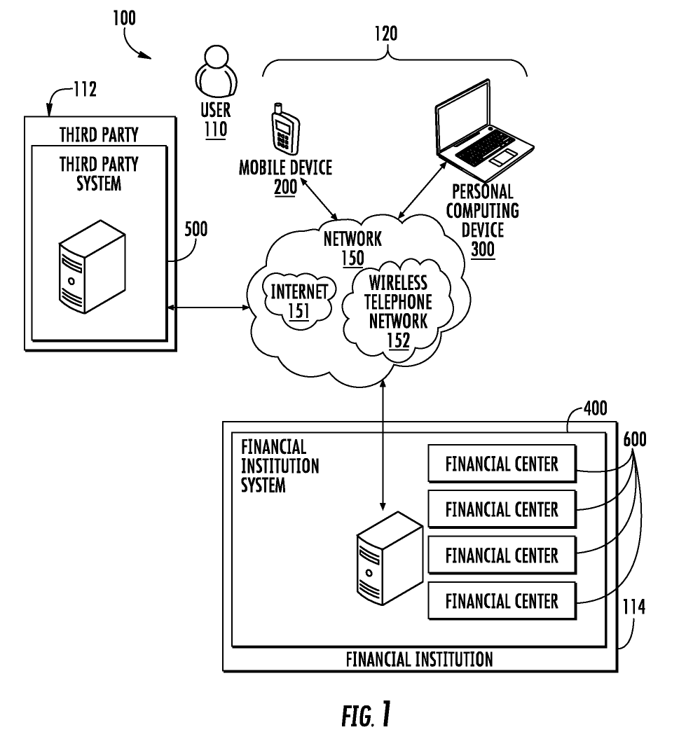

FIG. 1 provides a block diagram illustrating an environment 100 for a system for resource allocation at time of use and conservation of unused portion, in accordance with an embodiment of the invention. As illustrated in FIG. 1, the environment 100 includes a user 110 where the user represents a customer having a relationship with at least one but typically more than one entity such as a financial institution. A user of the system may be a person, but may also be a business or any other entity. In a typical environment a great number of users may access the system of the invention. The environment further includes a third party 112 where the third party 112 may comprise any person, business or other entity. In one embodiment the third party 112 may be a business such as a retail establishment, service provider, financial institution, or the like, including on-line and/or “brick and mortar” establishments, that has a relationship with the user 110. The third party 112 may have an ongoing relationship with the user by means of a customer loyalty program, subscription service or the like or it may have a transactional relationship with the user where the relationship is based on periodic transactions. The third party 112 also has a relationship with the entity such as a financial institution 114 where the third party 112 has an agreement with that entity to allocate user resources, such as benefits related to a transaction with the user, to the entity based on rules established between the third party and the entity as will hereinafter be described.

The environment 100 also may include at least one and in a typical case a plurality of user devices 120 accessible by the users 110. The user devices 120 may comprise any machine, apparatus, system or the like that may be connected to and communicate over network 150. At least one of the user devices may comprise a computing device for use by the user 110. The computing device may be any device that employs a processor and memory and can perform computing functions, such as a personal computing device 300 or a mobile device 200, that may be connected to or access network 150. The personal computing devices 300 may comprise a personal computer such as a desk top computer, lap top computer, tablet or any type of personal computing device that may be connected to a network by landline or wireless access such as wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile devices 200 may comprise any mobile communication device, such as a cellular telecommunications device (i.e., a cell phone or mobile phone), personal digital assistant (PDA), a mobile Internet accessing device, or other mobile device. A mobile device may connect to the network by a cellular telecommunications network or by WiFi, Bluetooth or other access technology. In some embodiments where, for example, the user 110 is an institution the user devices 120 may comprise servers, access terminals, or the like.

The user devices 120 may be configured to communicate over network 150 with at least one entity system such as financial institution system 400 of an entity such as a financial institution 114. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet 151. In one embodiment, the network 150 may also include a wireless telephone network 152.

In general, the user device 120 is configured to connect with the network 150 and may be used to log the user 110 into the financial institution system 400 of the financial institution 114. A user 110, in order to access the user's account(s), typically uses an online banking application and/or mobile banking application on the financial institution system 400 and must authenticate with the financial institution system 400. For example, logging into the financial institution system 400 generally requires that the user 110 authenticate his/her/its identity using a user name, a passcode, a cookie, a biometric identifier, a private key, a token, and/or another authentication mechanism that is provided by or for the user 110 to the financial institution system 400 via the user device 120. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the user has already logged-in to the user device 120 using an authentication procedure for the device such as a thumbprint or password. A soft authentication may require only a user identification such as user name. A soft level of authentication may be used, for example, where the user has already logged-in to the user device 120 using an authentication procedure for the device such as a thumbprint or password and the user has performed activities on the user device that are recognized as “normal” activity for that user and/or the user device is in a recognized location for that user. Thus, the level of authentication required for accessing the banking application, whether online, mobile or in person, may be adjusted based on conditions, activity, functions or information received about or from the user.

In one embodiment, the invention may provide an application download server such that software applications that support the financial institution system 400 can be downloaded to the user devices 120. In some embodiments of the invention, the application download server is configured to be controlled and managed by one or more third-party data providers (not shown in FIG. 1) over the network 150. In other embodiments, the application download server is configured to be controlled and managed over the network 150 by the same entity or entities that maintains the financial institution system 400

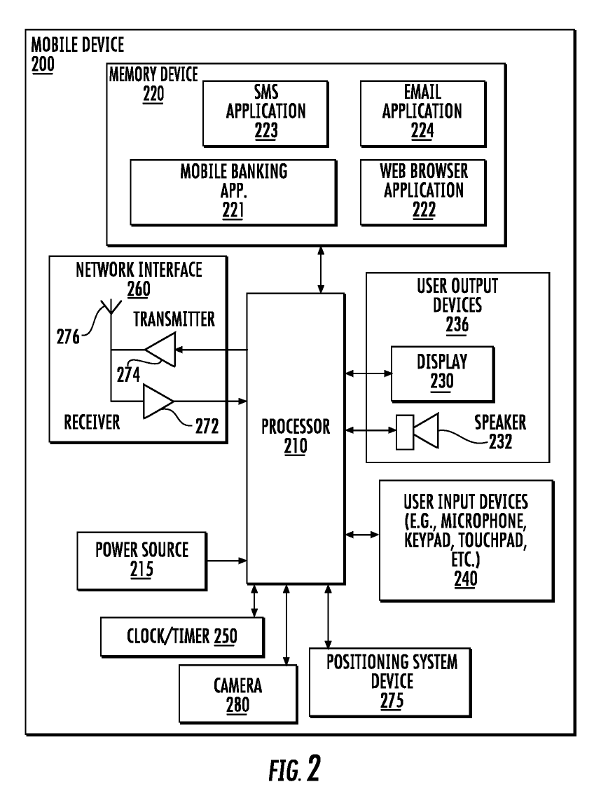

FIG. 2 provides a block diagram illustrating the mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, GPS devices, or any combination of the aforementioned.

Some embodiments of the mobile device 200 include a processor 210 communicably coupled to such devices as a memory device 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The mobile device 200 may also include a camera 280 and a positioning system device 275 such as a global positioning system (GPS). The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory device 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail app 224 and SMS app 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

As described above, the mobile device 200 has a user interface that may be made up of user output devices 236 and/or user input devices 240. The user output devices 236 may include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s).

The memory device 220 is operatively coupled to the processor 210. The memory device 220 can store any of a number of applications which comprise computer-executable instructions/code executed by the processor 210 to implement the functions of the mobile device 200 and/or one or more of the process/method steps described herein. The memory device 220 also includes a mobile banking application 221 that may be used to allow communication with a system such as the financial institution system 400 to implement the system of the invention. The use of the mobile banking application 221 may facilitate access to the system of the invention by providing log-in systems including user authentication systems, account information, system controls or the like. The mobile banking application 221 also allows communication to the financial institution system 400 to allow the user to set up and/or control the system of the invention.

A graphical user interface (GUI) may be provided on the display 230 that allows the user 110 to communicate with the mobile device 200, the financial institution system 400 and/or other devices or systems. The memory device 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory device 220 may include such data as user authentication information.

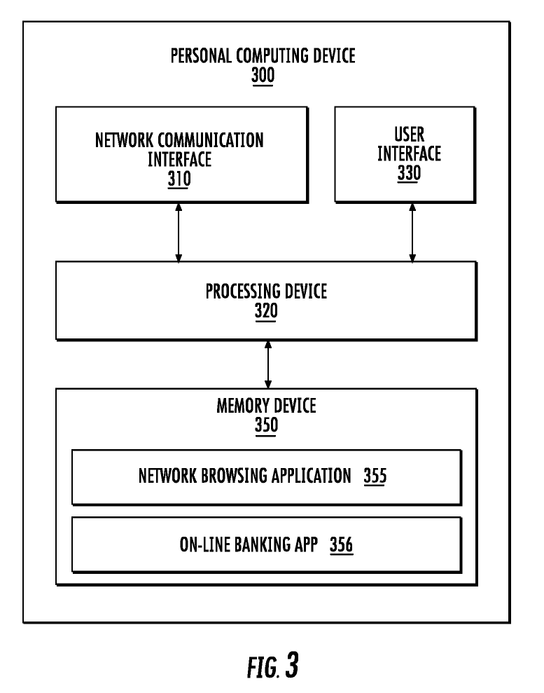

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150. In one embodiment of the invention, a network browsing application 355 provides for a user to establish network communication with a financial institution system 400. The memory device 350 may include such applications as the conventional web browser application 355 and/or an on-line banking application 356. The on-line banking application 356 may be used to allow communication with the entity system such as financial institution system 400 to provide access to the financial institution system providing log-in systems including user authentication systems, account information or the like as previously described with respect to FIG. 2. The on-line banking application 356 also allows communication to the financial institution system 400 to allow the user to set up and/or control the system of the invention.

As used herein, a “processor” or “processing device,” such as the processing device 320, processing device 420, processing device 520 and processor 210, generally refers to a device or combination of devices having circuitry used for implementing the communication and/or logic functions of a particular system. For example, a processing device or processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device or processor may further include functionality to operate one or more software programs based on computer-executable program code thereof, which may be stored in memory device. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of user input and output devices and/or software that allow a customer to input commands and data to direct the processing device to execute instructions and to receive communications from the user devices 120. For example, the user interface 330 identified in FIG. 3 may include a graphical user interface (GUI) or an interface to input computer-executable instructions that direct the processing device 320 to carry out specific functions and an output to communicate with the user 110 and/or third party 112. The user interface 330 employs certain user input and user output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory devices described herein include any computer memory that provides an actual or virtual space to temporarily or permanently store data and/or commands provided to the processing device when the processing device carries out its functions described herein. As used herein, “memory” or “memory device” includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

As used herein, a “communication interface” generally includes a modem, server, transceiver, and/or other device for communicating with other devices on a network. The network communication interface 410, 510 is a communication interface having one or more communication devices configured to communicate with one or more other devices on the network 150, such as the mobile device 200, and/or the personal computing device 300. The processing device 420 is configured to use the network communication interface 410 to transmit and/or receive data and/or commands to and/or from the other devices connected to the network 150.

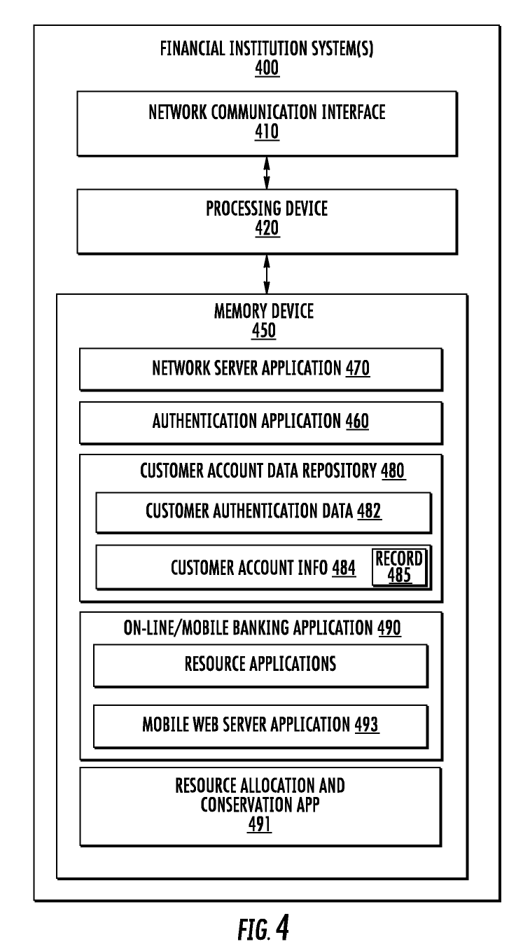

FIG. 4 provides a block diagram illustrating the entity system such as financial institution system 400, in greater detail, in accordance with embodiments of the invention. As illustrated in FIG. 4, in one embodiment of the invention, the financial institution system 400 includes one or more processing devices 420 operatively coupled to one or more network communication interfaces 410 and one or more memory devices 450. In certain embodiments, the financial institution system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the financial institution system 400 described herein. For example, in one embodiment of the financial institution system 400, the memory device 450 includes, but is not limited to, a network server application 470, an authentication application 460, a customer account data repository 480 which includes customer authentication data 482 and customer account information 484, an on-line/mobile banking application 490 comprising a mobile web server application 493, and other computer-executable instructions or other data such as resource applications for executing transactions with the financial institution. The computer-executable program code of the network server application 470, the authentication application 460, or the on-line/mobile banking application 490 may instruct the processing device 420 to perform certain logic, data-processing, and data-storing functions of the financial institution system(s) 400 described herein, as well as communication functions of the financial institution system(s) 400. The mobile banking application 490 communicates with the user computing devices 120 to facilitate communication between the user and the financial institution.

In one embodiment, the customer account data repository 480 includes customer authentication data 482 and customer account information 484. The network server application 470, the authentication application 460, and the mobile banking application 490 are configured to invoke or use the customer account information 484, the customer authentication data 482 when authenticating a user to the financial institution system(s) 400.

The financial institution system 400 further includes a resource allocation and conservation application 491 that communicates with the user device 120 and/or the third party system 500 as will be described. The resource allocation and conservation application 491 is configured to obtain user resources developed by the user's resource generating activities and to allocate and conserve those resources. In one embodiment “resource” means a user benefit developed as a result of a user transaction with a third party or developed as a result of the user's relationship with the financial institution 114. Examples of a user benefit are discounts, cash back rewards, loyalty program points, or the like. A user resource generating activity may be a transaction such as the purchase of services or goods, the use of a credit card or the like. Thus, an example of a user resource generating activity and associated resource would be the purchase of groceries using a loyalty card (user resource generating activity) that provides a price discount (user benefit/resource) based on the purchase of certain products. Another example of a user resource generating activity and associated resource would be the use of a credit card to make a purchase (user resource generating activity) that provides cash back (user benefit/resource) to the user. Another example of a user resource generating activity and associated resource would be the purchase of an airline ticket (user resource generating activity) that provides frequent flier miles or points (user benefit/resource) to the user. The resource allocation and conservation application 491 obtains the user benefits or information about the user benefits from the third party and allocates those user benefits, maintains a record 485 of the accumulated user benefits and conserves unused user benefits. The record 485 may be maintained as part of the customer account information 484 or it may be maintained as part of the resource allocation and conservation application 491 or the information may be distributed in different portions of the memory device 450. In all events the user record of the user benefits is maintained in the financial institution system 400 and the user benefits are accessible to the resource allocation and conservation application 491 for implementation of the system of the invention.

The environment may also comprise at least one financial center 600 (FIG. 1) that is related to and may form part of the financial institution that operates and controls the financial institution system 400. The financial center(s) 600 may be a branch office, an ATM machine or other type of facility that may provide in-person customer service and support for the financial institution. The financial centers 600 may also include centralized facilities that are accessible by the distributed financial centers. Typically, the financial institution system 400 comprises a plurality of financial centers that are geographically dispersed to provide services to the financial institution's customers over a wide, and potentially international, geographic area. The financial centers 600 may include at least portions of the financial institution systems 400 that allow each financial center 600 to communicate with other elements of the financial institution system 400 and the user devices 120 over network 150. Each financial center 600 may have access to all or a portion of the financial institution system(s) 400 such that each financial center 600 can communicate with and access at least portions of the processing device 420 and memory device 450 of the financial institution system and in some embodiments the various local systems of the financial centers 600 may be considered to be part of a distributed financial institution system 400. Thus, while the financial centers 600 may be geographically distributed, the financial centers 600 may be considered to form part of the financial institution system(s) 400 as previously described. Each financial center 600 typically includes local processing devices 420 and memory devices 450 and network interface devices 410 that allow the local system of the financial centers 600 to communicate over the network 150 with one another and with centralized systems of the financial institution. The financial centers 600 may also comprise a local customer account data repository, a local online/mobile banking application, a local resource monitoring and alert application facilitate communication, data management and security among the financial centers.

In a typical relationship the user 110 is a customer of the financial institution 114 that operates financial institution system 400 and engages the financial institution for a variety of services and products. The user may have relationships with more than one financial institution and the relationship between each user and a financial institution may be different where different products and services are provided by the financial institution and/or utilized by the user. In a typical relationship the user 110 may be able to utilize applications such as on-line/mobile banking applications 490 of the financial institution that can be accessed through user device 120 to obtain services and products offered by the financial system 400 and to complete financial transactions with and/or through the financial institution. Moreover, at least some of the services and products that are available through the on-line/mobile banking applications 490 are also available as physical transactions. There may also exist some services and products that are available only as physical transactions through a financial center 600. An exemplary suite of products and services may include some or all of, but is not limited to, the following: savings/checking accounts, money transfers, mobile/electronic and/or physical check deposit, person-to-person payments (P2P), account statements (checking, savings, term deposits, loans card, equity/fund, insurance and the like), bill payment, cloud storage, ATM withdrawal, financing, portfolio management, stock quotes, location based services, loyalty related agreements, loans, debit/credit cards and the like. The example products and services set forth above are not intended to be limiting or exhaustive of the relationship that a user may have with a financial entity system.

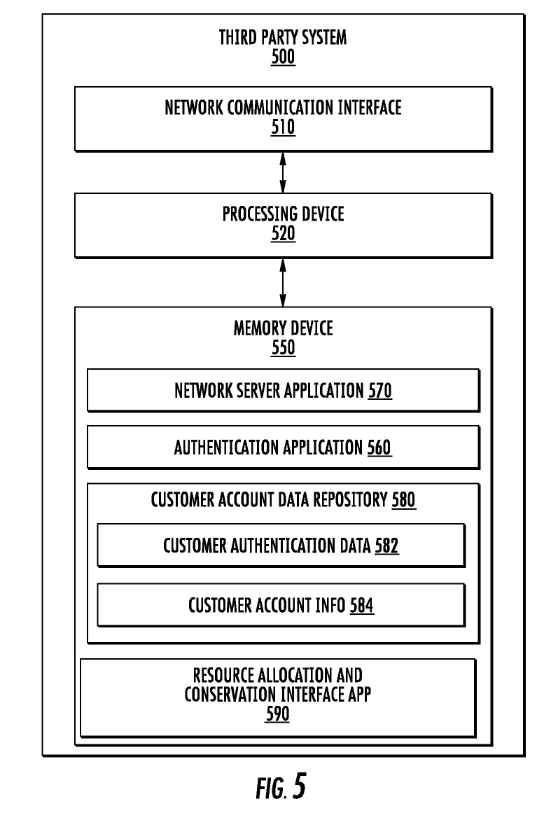

FIG. 5 provides a block diagram illustrating an embodiment of a third party system 500, in greater detail, in accordance with embodiments of the invention. The third party system 500 is operated under the control of the third party 112 to implement the invention as described herein. As previously described the third party 112 may comprise any person, business or other entity. In one embodiment the third party 112 may be a business such as a retail establishment, service provider, financial institution, on-line retailer or the like, and may include both on-line and/or “brick and mortar” establishments. The third party 110 may have an ongoing relationship with the user by means of a customer loyalty program, subscription service, ongoing account or the like or it may have a transactional relationship with the user where the relationship is based on periodic, or even one-time, transactions. The third party 112 also has a relationship with the financial institution 114 where the third party 122 has an agreement with the financial institution 114 to provide information to and/or engage in financial transactions with the financial institution based on the rules that control the interaction between the third party system 500 and the financial institution system 400 as will hereinafter be described. Because the third party 112 may be any type of establishment having a relationship with the user, the third party system 500 described herein is described to the extent necessary to understand and implement the system of the invention. The third party 112 may also operate systems in addition to those described herein and the third party systems may comprise a wide variety of systems such as inventory systems, logistics, accounting systems, shipping systems and the like that are necessary to operate the third party enterprise but that are not relevant to the operation of the system of the invention.

As illustrated in FIG. 5, in one embodiment of the invention, the third party system 500 includes one or more processing devices 520 operatively coupled to one or more network communication interfaces 510 and one or more memory devices 550. The memory device 550 may include one or more databases or other data structures/repositories. The memory device 550 also includes computer-executable program code that instructs the processing device 520 to operate the network communication interface 510 to perform certain communication functions of the third party system 500 described herein. For example, in one embodiment of the third party system 500, the memory device 550 includes, but is not limited to, a network server application 570, an authentication application 560, a customer account data repository 580 which may include customer authentication data 582 and customer account information 484, and other computer-executable instructions or other data such as resource applications for executing transactions with the third party. The computer-executable program code of the network server application 570, or the authentication application 560 may instruct the processing device 520 to perform certain logic, data-processing, and data-storing functions of the third party system 500 described herein, as well as communication functions of the third party system 500. In one embodiment, the customer account data repository 580 includes customer authentication data 582 and customer account information 584. The network server application 570 and the authentication application 560 are configured to invoke or use the customer account information 584 and the customer authentication data 582 when authenticating a user to the third party system 500. For example, the authentication may include the swiping of a loyalty card or the entry of a PIN number that is recognized by the third party system 500 to identify the user. The customer account information 584 may comprise customer identification information, loyalty or rewards points, user usage rates, user spend rates, purchase histories or the like.

The third party system 500 further includes a resource allocation and conservation interface application 590 that communicates with the financial institution system 400 as will be described. The resource allocation and conservation interface application 590 functions to obtain user resources developed by a user's utilization of user resource generating activities with that third party and to transmit relevant information to the financial institution system 400 based on the rules established in the agreement between the financial institution 114 and the third party 112. As previously explained the resource is the user benefit (e.g. loyalty rewards (points), discounts, special deals, coupon savings or the like) developed as a result of the user resource generating activity (e.g. transactions such as purchases, rentals, leases, usage or the like) with the third party.

In a typical relationship the user 110 is a customer of the third party 112 that engages the third party for a variety of services and products. The user may have relationships with more than one third party and the relationship between each user and the third party may be different where different products and services are provided by each of the third parties and/or utilized by the user. The third parties are independent of one another and the user benefits provided by the third parties to the user may vary. In a typical relationship the user 110 may be able to obtain or purchase goods and services from a third party through user device 120 and/or through physical transactions such as at a third party retail outlet. The types of third parties and the products and services offered by the third parties and obtained or purchased by the user can vary greatly. For example a third party may be a retailer such as a grocery store, department store, specialty store or the like where the user purchases products. Other third parties may be service providers such as airlines, hotels, rental car companies or the like. Other third parties may be on-line e-commerce retailers that sell products from a variety of merchants. While specific examples of third parties are provided herein the examples are not intended to be exhaustive or limiting. The third party may be any entity with which the user has a relationship that may make use of the present invention.

Some of the products and services offered by the third party comprise a user resource activity that results in the user obtaining resources such as discounts, cash back rewards, preferred pricing, coupons, or loyalty points or other rewards and benefits, referred to herein collectively as user benefits. For example, a retailer such as a grocery store may provide the user with a loyalty card that provides price discounts to the user at the point of purchase. Department stores may provide the user with preferred pricing such as percentage discounts where the user may save a certain percentage on all purchases on a particular date and/or if made with the store's credit card. An airline may offer fare discounts to for loyalty milestones.

The financial institution system 400 obtains the user benefits, or information about the user benefits, earned by the user from the third parties and maintains a record 485 of the aggregated user benefits in memory device 450. The record 485 may be maintained as part of the user account information 484 or it may be maintained as part of the resource allocation and conservation application 491 or the information may be distributed in different portions of the memory device 450. In all events the record 485 of user benefits is accessible to the resource allocation and conservation application 491 for implementation of the system of the invention.

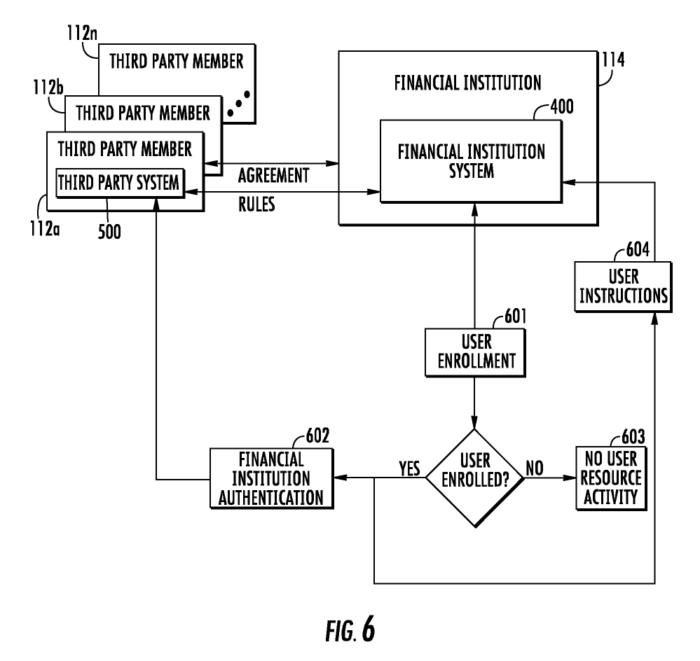

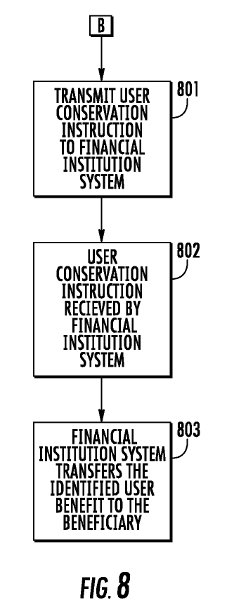

An embodiment of the resource allocation and conservation application 491 will be described with reference to FIGS. 6 through 8. FIG. 6 is a schematic drawing illustrating an embodiment of the arrangement between the user 110, third party 112 and the financial institution 114. In one embodiment, the financial institution 114 and a plurality of third parties 112a-112n enter into agreements to share information and/or engage in a financial transactions to implement the system of the invention. A third party that enters into such an agreement may be referred to herein as a third party member. In a typical system a plurality of unrelated an independent third party members 112a-112n have agreements with the financial institution 114. Each third party system 500 provides information to, or engages in a financial transaction with, the financial institution system 400 based on the rules established in the agreement. The rules may depend in part on the type of third party and the nature of the user benefits obtained by the user as a result of its transactions with the third party. For example, the third party may offer user benefits such as cash back, discounts, free goods or services or the like. Based on the nature of the user benefits offered by the third party the rules of the agreement may require that the third party system 500 transmit a payment to the financial institution system 400 or the rules may require that the third party system 500 transmit information related to the user benefit to the financial institution system 400 without transmitting a payment or the rules may require that the third party system 500 transmit information related to the user benefit and a payment to the financial institution system 400. The information and or financial transaction transmitted from the third party system 500 to the financial institution system 400 is referred to collectively as user benefit data.

Once the agreements between the financial institution 114 and the third party members 112a-112n are established the user 110 may enroll in the system for any third party member with which the user has a relationship (Block 601). In one embodiment the user may enroll in the system over user device 120, where, after the user is authenticated with the financial institution, the user may utilize the mobile banking application 221 or on-line banking application 356 to enroll in the system through financial institution system 400 over network 150. The user 110 may also enroll in person at a financial center 600 or by other means such as regular mail. After the user enrolls in the system, the financial system 400 may transmit an authentication to all third party members authorizing the third party members to transmit the user benefit data to the financial institution (Block 602). If the user does not enroll in the system the system will not be active for that user (Block 603).

The user may provide instructions to the financial institution system 400 instructing the financial institution system 400 how the user benefit is to be allocated (Block 604). In some embodiments the user may direct the types of user benefits or identify the third parties either specifically or as a class for which the system of the invention is to be used. The user may also direct how the user benefits aggregated by the financial institution system 400 from the third party members are to be accounted for by the financial institution system. For example, the user may identify a designated account for receiving the payments from the third party. The designated account may also be identified by the user based on other relationships with the financial institution. For example, where the user has established a relationship with the financial institution and where that relationship has established personalized services such as savings plans, budgeting plans or the like the system of the invention may be used in conjunction with such personalized services such that certain of the user benefits are accounted for in one manner and certain of the user benefits are accounted for in a second manner. For example one user benefit may be deposited into a first designated savings account earmarked for a particular purpose and a second user benefit may be deposited in a second designated account. In either event the user benefits accumulated by the user and tracked by the financial system may be maintained in an aggregated record that may be accessed by the user such that all of the user benefits may be easily presented to the user regardless of the final disposition of the user benefit.

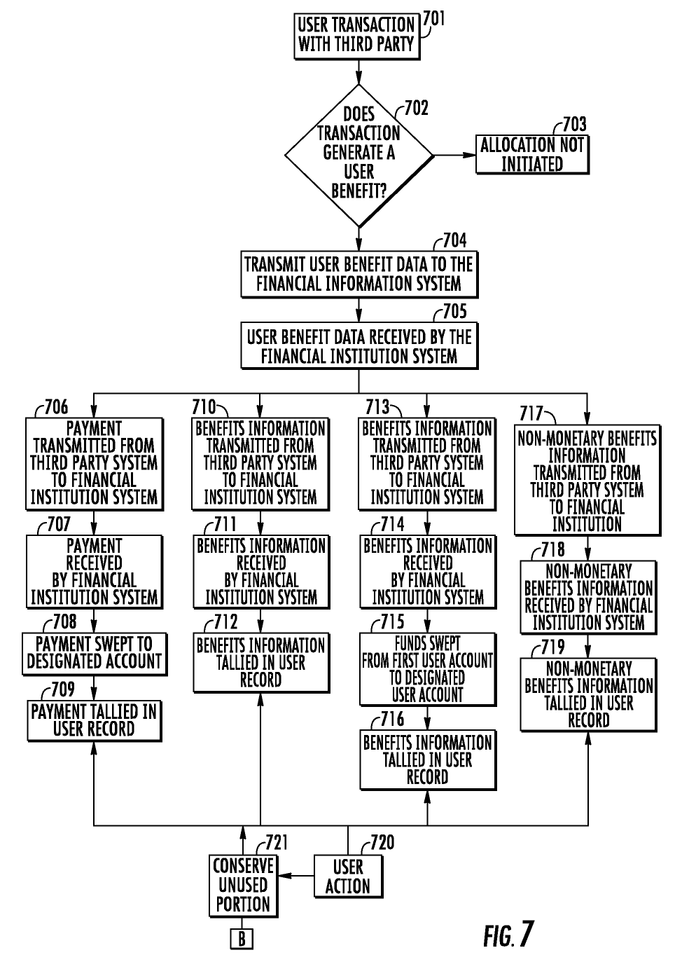

The operation of the system of the invention will be described with reference to FIG. 7. In describing the operation of the system it is assumed that agreements are in place between the financial institution and the member third parties that establish rules for the third party systems 500 and the financial system 400 for how and when user benefit data will be transmitted from the third party systems to the financial institution system and that the user has enrolled in or otherwise consented to use the system of the invention. The user engages in a transaction with a member third party (Block 701). The transaction may be over a user device 120 or it may be a physical transaction such as at the third party's place of business. The third party system determines if the transaction generates a user benefit as set forth under the rules established between the financial institution and the third party (Block 702). If the transaction does not generate a user benefit, the system is not initiated and no further action is taken by the third party (Block 703). If the transaction generates a user benefit, the user benefit data is transmitted from the third party system to the financial institution system on a per transaction basis as controlled by the resource allocation and conservation interface application 590 (Block 704). That is, for each transaction that creates a user benefit the user benefit data is transmitted to the financial institution system upon completion of the transaction. The user benefit data may be transmitted in a number of formats depending upon the type of user benefit created and the financial institution system 400 may allocate the user benefit in different ways. The transmitted user benefit data is received at the financial institution system 400 (Block 705).

In one embodiment the user benefit data comprises a payment or authorization for a payment from the third party system 500 to the financial institution system 400 (Block 706). Such an arrangement may be used where the user benefit is a monetary payment to the user. Such a user benefit may take the form of a cash back offer, a rebate or the like where the user benefit is a monetary payment from the third party to the user. The third party system may, based on the rules established between the third party, the financial institution and the user, make the payment directly to the financial institution system 400. The payment transmitted by the third party system 500 is received by the financial institution system 400 (Block 707). Upon receipt of the payment, the financial institution system 400 may post the payment to a designated user account such as a user savings account per the financial institution's agreement with the user (Block 708). Where the user benefit comprises a monetary payment the payment may be considered to be “swept” into the user account. In addition to sweeping the payment into the designated user account, the financial institution system 400 also updates the user record 485 managed by the resource allocation and conservation application 491 to tally the payment. In this manner the user record 485 is updated on a transaction by transaction basis. In this and other embodiments, the designated account may be part of a larger relationship between the user and the financial institution where, based upon the user's financial goals and plans, predetermined user benefits are earmarked for the designated account.

The user record 485 may be accessed by the user via user device 120 and may be reviewed by the user such that the user may gain insight into the user benefits accumulated over a period of time. The user record 485 may be accessed via user devices 120 such that the user may obtain real time information regarding the accumulated user benefits. The user record 485 may show any relevant information, for example, the amount of payment, the source of payment, the transaction details such as date, product and/or service purchased, the designated account, the designated account balance and the like. Moreover where the designated account is part of a larger user relationship with the financial institution the user record 485 may track progress toward a predefined goal. The goal may be expressed in terms of a monetary amount, points total, percentage of savings, percentage of income or the like.

In another embodiment the user benefit may be a discount or savings on the purchase of a goods or services from the third party rather than a payment from a third party. For example, the user may have a loyalty card with a third party where when the card is presented at the time of purchase the cost of goods purchased may be reduced by a percentage, dollar amount or the like. In such an arrangement the resource allocation and conservation interface application 590 of the third party system 500 may transmit to the financial institution system 400 the user benefit data including the saved amount (i.e. the discount) on a transaction by transaction basis (Block 710). The user benefit data including the saved amount is received by the financial institution system 400 (Block 711). The user record 485 maintained by the resource allocation and conservation application 491 is updated to tally the saved amount (Block 712). The user record 485 may show any relevant information, for example, the saved amount, the cost of goods/services, the percentage of savings, the transaction details such as third party identity, date, product or service purchased, and the like. In this manner the user record 485 is updated on a transaction by transaction basis. The user record 485 may be reviewed by the user such that the user may gain insight into the user benefit (savings) accumulated over a period of time. The running totals may be accessed via user devices 120 such that the user may obtain real time information regarding the accumulated user benefits. In such an embodiment the system tallies the user benefit but does not necessarily sweep an actual user benefit into a user account.

In another embodiment the user benefit may be a discount or savings on the purchase of a goods or services such as described above. In another example, the third party may be a department store that has preferred customer lists where a user that is a preferred customer may obtain savings in the cost of goods at the time of purchase. The savings may be received when the user provides a code to the third party department store at the time of the transaction. In such an arrangement the resource allocation and conservation interface application 590 of the third party system 500 may transmit to the financial institution system 400 user benefit data including the saved amount on a transaction by transaction basis (Block 713). The user benefit data including the saved amount is received by the financial institution system 400 (Block 714). The user record 485 maintained by the resource allocation and conservation application 491 is updated to tally the saved amount (Block 716). In addition to tallying the user benefit, the resource allocation and conservation application 491 may make a monetary transfer by sweeping the saved amount from a first user account into a second designated user account based on the rules established in the agreement between the user and the financial institution system 400 (Block 715). For example, the rules may direct that the resource allocation and conservation application 491 of the financial institution system 400 transfer funds equal to the user benefit (saved amount) for the reported transaction from a user's general savings account into a designated account for such user benefits.

The user record 485 may show any relevant information, for example, the amount of payment, the amount of savings, the percentage of savings, the transaction details such as retailer identity, date, product or service purchased, the amount of funds transferred, the source of the funds, the designated account, the source account balance, the designated account balance, and the like. In this manner the user record 485 may be reviewed by the user such that the user may gain insight into the user benefit (savings) accumulated over a period of time. The user record 485 may also show information related to a user goal as previously described. The running totals may be accessed via user devices 120 such that the user may obtain real time information regarding the accumulated user benefits.

In other embodiments the user benefit may be a non-monetary benefit. For example, in a loyalty program such as a “frequent flier” type of program the user benefit may be miles or points. Non-monetary rewards are referred to herein as “points”. The resource allocation and conservation interface application 590 of the third party system 500 may transmit to the financial institution system 400 user benefit data comprising the non-monetary user benefits (Block 717). The user benefit data including the non-monetary information is received by the financial institution system 400 (Block 718). The user record 485 maintained by the resource allocation and conservation application 491 is updated to tally the non-monetary information, e.g. points (Block 719). The record may show any relevant information, for example, the number of points for the transaction, the total number of points accumulated, the transaction details such as retailer identity, date, product or service purchased, and the like. The record may also show potential goods and services that may be obtained with the accumulated points. The user record 485 may also show information related to a user goal as previously described. In this manner the user record may be reviewed by the user such that the user may gain insight into the user benefit accumulated over a period of time. The running totals may be accessed via user devices 120 such that the user may obtain real time information regarding the accumulated user benefits that form the user record.

Because the user has control over the user's accounts with the financial institution and the allocation of the user benefits, the resource allocation and conservation application 491 also updates the user record 485 when the user takes action on an account (Block 720). For example, if the user makes a withdrawal from or a deposit to an account, the user record 485 is updated to reflect the withdrawal and/or deposit and the balance is updated. For non-monetary items such as points, when the user redeems the points, miles or other non-monetary item, the third party system 500 may transmit user benefit data including the points redeemed and/or the monetary value of the redeemed points to the financial institution system 400. The financial institution system 400 updates the user record to show the points reduction and the number of available points. If the redemption of points resulted in cash back to the user the cash may be handled as described with reference to Blocks 706-709. If the redemption of points resulted in a benefit that did not result in a cash payment, the user benefit may be handled as described with reference to Blocks 710-712 or Blocks 713-716. The user record may also be updated to show the monetary value of the product or service obtained.

In operation the user completes a transaction with a third party system 500 that is a third party member with the financial institution operating the system where that transaction develops a user benefit. The third party system 400 transmits a message to the financial institution system 500 including user benefit data. In one embodiment the resource allocation and conservation interface application 590 of the third party system 500 transmits a secured message such as a tokenized message to the financial institution system 400 over network 150 via network communication interface 510 based on information stored in memory device 550. The secured message comprises user benefit data is recognized by the resource allocation and conservation application 491 as relating to a resource such as a user benefit that is developed as a result of a user resource generating activity such as a transaction with a member third party. The secured message is informed by and transmitted in accordance with the terms and conditions of the agreement between the third party system 500 and the financial institution system 400. Tokenization security systems are known where a token having no intrinsic value is substituted for sensitive data such that the transmission of the user benefit information does not involve the transmission of sensitive data. As a result, security is enhanced and security risks from data breaches are reduced. In the present invention the secured message may be substituted for user identification information such that the secured message generated by the resource allocation and conservation interface application 590 is translated and attributed to a particular user at the financial institution system 400. The secured message is translated by the resource allocation and conservation application 491 to identify the user's identity and the source of the secured message. The secured message may also include information about the transaction, user benefit or other information.

The secured transmission is on a transaction basis where the financial institution system 400 receives the relevant user benefit for each transaction from the third party upon completion of the transaction. The resource allocation and conservation application 491 may also pull information from the financial institution system 400 records to make this information part of the user record 485 where it may be available to the user as previously described. Where the resource allocation and conservation application 491 obtains the information for the user benefit from memory device 450 of the financial institution system 400, the financial institution may be thought of as both the third party and the financial institution. For example, the financial institution may offer incentives to the user for various user activities with the financial institution such as cash back rewards, loyalty points, rewards programs and the like. Because this information is internal to the financial institution system 400 the financial institution does not necessarily receive a secured transmission containing this information. Rather this information may be accessed internally by the resource allocation and conservation application 491 on a transaction by transaction basis. Because this information is maintained as part of the user record, the user record provides a complete record of all user benefits.

Once the user record 485 is created, the user record may be used in a variety of manners for the benefit of the user. The user record 485 may be accessed by the user via a user device 120 using on-line banking application 356 and/or mobile banking application 221. In this manner the user has a continuously updated view of the user record 485 for all user benefits obtained by the user from member third parties. The on-line/mobile banking applications may allow the user to update instructions to the financial institution as to how different benefits are to be allocated, displayed or the like. Because the financial institution system 400 has access to the aggregated data of its users, the financial institution system 400 may use the aggregated data to provide analysis for its users. For example, the financial institution may compare the user benefits obtained by one particular user against other similarly situated users and provide analysis to the user indicating, for example, how the user's performance compares to other similarly situated users. For example, the analysis may indicate that the user is in the top 10% of user benefits for households having a similar household income. The analysis may also be used to provide guidance to the user for better managing the user benefits. For example, the financial institutions analysis may reveal that users of a first loyalty program obtain more benefits than users of a similar second loyalty program. The analysis may also reveal that based on a user's financial activity the user may benefit from a particular third party program or offer. This analysis may be provided as a service to the user. The analysis may be presented on the user device 120 when the user accesses the on-line banking application 356 and/or mobile banking application 221.

In other embodiments the financial institution system 400 may be used as a conduit for delivering third party content to the users to provide users with offers of user benefits that may be of value to the user. In such an embodiment the financial institution system 400 may determine via its analysis of the user record and the aggregated information of all its users that a user benefit may be relevant to a user based on the user's resource activity. For example the financial institution system 400 may determine that the user shops at a particular store based on the user's credit/debit card history but that the user does not use that store's loyalty program. The financial institution system 400 may transmit a message to the user device 120 informing the user device about the potential user reward and providing a link or other information that enables the user's enrollment in the loyalty program.

In some embodiments, the analysis may be based on predictive models of user resource activity rather than on actual user resource activity. The system may predict the need for certain services or products based on known data about the user when compared to aggregated data from the financial institution system users. For example, the system may predict that a user might be in a position to travel and may transmit a message to user device 120 with a special offer on air fare or the like. Numerous other examples may be provided of the use of a predictive model for initiating the system of the invention and the examples provided above are not intended to be limiting.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s).

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7259US1.014033.2850 | To be assigned | RESOURCE TRACKING | Concurrently |
| | | AND UTILIZATION | herewith |
| | | SYSTEM | |
| 7261US1.014033.2851 | To be assigned | RESOURCE ASSIGNMENT | Concurrently |
| | | SYSTEM | herewith |
| 7262US1.014033.2852 | To be assigned | RESOURCE ASSIGNMENT | Concurrently |
| | | SYSTEM WITH | herewith |
| | | ALLOCATION ASSIST | |
| 7263US1.014033.2853 | To be assigned | SYSTEM FOR RESOURCE | Concurrently |
| | | ALLOCATION AT TIME OF | herewith |
| | | USE AND CONSERVATION | |
| | | OF UNUSED PORTION | |
| 7265US1.014033.2855 | To be assigned | SYSTEM FOR | Concurrently |
| | | MONITORING RESOURCE | herewith |
| | | ACTIVITY AND ALERT | |
| | | GENERATION | |

1. A resource allocation and conservation system comprising:
a network communication interface;
a memory device storing a resource allocation and conservation application;
a processing device operatively coupled to the memory device, wherein the processing device is configured to execute computer-readable program code to:
receive a user resource data based on a user resource activity from a third party system associated with one of a plurality of independent third parties;
update a user record in the memory device with a user resource based on the user resource data and allocate the resource.

2. The system of claim 1 wherein the user resource activity comprises a financial transaction.

3. The system of claim 1 wherein the user resource is received at the time of the user resource activity.

4. The system of claim 1 wherein the user resource comprises a user benefit including at least one of a monetary payment, a rebate, a discount, a reward, and a point.

5. The system of claim 1 wherein the user resource comprises a monetary payment and the monetary payment is swept into a user designated account.

6. The system of claim 1 wherein the user record is accessible via a user device.

7. The system of claim 1 wherein the user record tracks progress toward a predefined goal.

8. The system of claim 1 wherein the user resource comprises a saved amount and a second amount is swept from a first user account into a second designated user account where the second amount is equal to the saved amount.

9. The system of claim 1 wherein the user resource comprises points and the user record comprises a tally of accumulated points and the processing device receives an accounting of redeemed points from the third party system.

10. A method for allocating and conserving resources, the method comprising:
receiving user resource data based on a user resource activity from a third party system associated with one of a plurality of independent third parties;
updating a user record in the memory device with a user resource based on the user resource data and allocating the resource by tallying and or sweeping the user resource.

11. The method of claim 10 wherein the user resource activity comprises a financial transaction with the third party.

12. The system of claim 11 further receiving the user resource at the time of the transaction.

13. The method of claim 10 wherein the user resource comprises a user benefit including at least one of a monetary payment, a rebate, a discount, a reward, and a point.

14. The method of claim 10 wherein the user resource comprises a monetary payment and further including sweeping the monetary payment into a user designated account.

15. The method of claim 10 further receiving a request for the user record from a user device.

16. The method of claim 10 tracking the user resource for progress toward a predefined goal.

17. The method of claim 10 wherein the user resource comprises a saved amount and further sweeping a monetary amount from a first user account into a second designated user account where the monetary amount is equal to the saved amount.

18. The method of claim 10 wherein the user resource comprises points and further tallying accumulated points in the user record and receiving an accounting of redeemed points from the third party system.

19. A resource allocation and conservation system comprising:
a network communication interface;
a memory device storing a resource allocation and conservation application;
a processing device operatively coupled to the memory device, wherein the processing device is configured to execute computer-readable program code to:
receive user resource data in a secured message, the user resource data based on a user resource activity from a third party system associated with one of a plurality of independent third parties;
allocate a user resource based on the user resource data to tally and/or sweep the user benefit.

20. The system of claim 19 wherein the user resource activity relates to a transaction with the third party where the transaction generates the user resource.
